(19) United States
(12) Patent Application Publication
(10) Pub. No.: US 2022/0363579 A1
(43) Pub. Date: Nov. 17, 2022

(54) OXYGEN FOR COMBUSTION IN FOREHEARTHS

(71) Applicant: PRAXAIR TECHNOLOGY, INC., Danbury, CT (US)

(72) Inventors: William Kobayashi, Williamsville, NY (US); Abilio Tasca, São Paulo (BR); Ritesh Kumar Nath, Karnataka (IN); Hisashi Kobayashi, Bedford, NY (US); Julien Pedel, Amherst, NY (US); Arthur W. Francis, Clarence Center, NY (US); Gaurav Kulkarni, East Amherst, NY (US)

(21) Appl. No.: 17/767,089

(22) PCT Filed: Oct. 1, 2020
(86) PCT No.: PCT/US2020/053699

§ 371 Date: Apr. 7, 2022

Related U.S. Application Data
(60) Provisional application No. 62/929,199, filed on Nov. 1, 2019.

(51) Int. Cl. C03B 7/06; C03B 5/235

(52) U.S. Cl. CPC C03B 7/065; C03B 5/2353; C03B 2211/60

(57) ABSTRACT

Efficiency of the combustion that is carried out in the forehearth of a glass manufacturing facility is improved by replacing air-fuel burners with a smaller number of air-fuel injectors and oxygen injectors.

### RELATED APPLICATIONS

This application claims the benefit of International Application No. PCT/US2020/053699, filed on Oct. 1, 2020, which claimed the benefit of U.S. Provisional Application Ser. No. 62/929,199, filed on Nov. 1, 2019, which are incorporated herein by reference.

### FIELD OF THE INVENTION

The present invention relates to manufacture of glass and glass products, and relates more particularly to the section of a glass manufacturing system known as the forehearth.

### BACKGROUND OF THE INVENTION

The manufacture of glass typically includes the melting together, in a furnace, glassforming raw materials which can include silica and/or one or more oxides, hydroxides, and/or silicates of alkali metals and alkaline earth metals, such as soda ash and the like (known as “batch”) and/or pieces of glass (known as “cullet”) in a furnace. Molten glass from the furnace then flows through a network of refractory channels, called the forehearth system (described below with respect to FIG. 1), to forming machines where the glass is then formed into desired products such as tableware or fiberglass. The main objective of a forehearth system is to maintain the molten glass at a target temperature so as to control viscosity of the glass prior to its reaching the forming machines. The conditions in the forehearth system also need to ensure that the viscosity and temperature of the molten glass is uniform throughout the volume of the flowing glass stream (preferably at uniform levels) within a tight range which is important for a constant flow of glass through the forehearth channels and for the forming machines to operate efficiently.

Glass forehearth systems are typically fitted with burners that combust premixed air-fuel mixtures (known as air-fired systems) firing perpendicular to the flow of glass (as described below with respect to FIG. 2). Air fired systems are typically characterized with low energy efficiency due to the high flow rate of the mixture of gases (known as flue gas) formed by the combustion of air and fuel. Typically more than 50% of the total heat energy from combustion in air fired systems is lost through the flue gas leaving the air fired system. Replacing air-fuel firing in a glass forehearth system with oxy-fuel (that is, combustion of fuel with gaseous oxidant containing 40% up to 100% oxygen) would be expected to result in a significant reduction of flue gas flow rate which directly results in fuel savings as less fuel needs to be combusted to provide desired heat transfer to the molten glass. Theoretically the highest fuel savings is achieved by replacing air-fuel firing with 100% oxy-fuel firing, essentially replacing air with oxygen completely, but this may not be the most economical approach due to the high cost of installing a 100% oxy-fuel combustion system. Whereas at 40% oxygen enrichment (average percentage of oxygen in the gaseous oxidant being combusted) fuel savings between 50% and 60% can be achieved compared to an air-fuel system, the theoretical maximum fuel savings is between 55% and 75% with 100% oxy-fuel firing. Beyond 40% oxygen enrichment the fuel savings tend to flatten out. That is, as the percentage of oxygen enrichment increases, the consumption of oxygen increases but the fuel savings flatten out essentially making the economics not as compelling for a 100% oxy-fuel fired forehearth system with the high initial cost.

In addition to the limited fuel savings, and the cost, of implementing oxy-fuel firing in the forehearth systems, another disadvantage of a 100% oxy-fuel system is the low flow rate of gases to each individual burner in the forehearth system. The combustion space in a glass forehearth system is typically divided into separate zones. Each of these zones is retrofitted with rows of small burners (typically made out of a low grade stainless steel) about 100 mm to 120 mm apart. A forehearth burner block typically houses multiple burners, usually three or four burners. Each combustion zone of a forehearth can have anywhere between 20 to 50 burners depending on the length of the zone. Replacing air-fuel firing with 100% oxy-fuel firing will reduce the gas flow rates from the burners into the combustion zone by approximately 80%.

These reduced flow rates exiting the burners can lead to overheating of the burners and may cause severe coke formation leading to burner failure. Preventing deposit build up on nozzle tips at the exit ends of burners is an important process requirement, especially when no cover plates are used to separate the combustion space of the forehearth system from the molten glass. The deposit of coke or condensable vapors on the nozzle may deflect the direction of the gas jet and often results in flame deflection/impingement or local hot spot. Burner ports and nozzles and fuel and oxygen flows would thus need to be designed carefully to prevent overheating of nozzles and formation of deposits at the nozzle tip. The problem of fuel cracking and coke build up is particularly severe when gaseous fuel contains higher hydrocarbons such as ethane, propane and butane.

Thus, retrofitting an existing forehearth system that employs air fired systems with 100% oxy-fuel firing system is not so attractive for the reasons previously mentioned above and also because it may lead to increased capital expenditure and increased maintenance costs as the burners and burner blocks may need to be redesigned and periodically serviced to remove unwanted deposits of coke and other condensates.

### BRIEF SUMMARY OF THE INVENTION

The present invention avoids the aforementioned drawbacks of 100% oxy-fuel firing in a forehearth system, while unexpectedly providing other advantages.

This invention is useful in several different types of forehearth systems, and has several different ways in which it can be implemented within each type of forehearth system.

In one type of forehearth system, to which this invention is applicable, heat is provided to the top surface of the molten glass from flames generated by combustion in the space above the molten glass, by direct heat transfer by which is meant by radiation and convection directly through space not occupied by an intervening solid structure in the path between the flames and the molten glass. That is, there is no physical barrier (also referred to as a cover) between the flames of combustion and the top surface of the molten glass.

For this type of forehearth system, one embodiment of the invention is a method comprising:

from a forehearth system in which molten glass from a glassmelting furnace flows through one or more channels having refractory side walls, wherein the molten glass in the channels is maintained in the molten state by heat of combustion provided directly to the top surface of the molten glass by combustion in a combustion zone above the molten glass in the forehearth system that has at least 2 air-fuel burners at which air and fuel fed to the air-fuel burners are combusted to provide the heat of combustion,

removing at least 50% , preferably all of said air-fuel burners and replacing them with one or more air-fuel injectors each of which opens at its own refractory port in a side wall of the channel and each of which is capable of injecting a premixed mixture of air and fuel into the space in the channel over the molten glass, and with one or more oxygen injectors each of which opens at its own refractory port in a side wall of the channel and each of which is capable of injecting gaseous oxidant into the space in the channel over the molten glass,

wherein the sum of the number of said air-fuel injectors plus the number of said oxygen injectors, which replace said air-fuel burners, is less than the number of air-fuel burners that are removed, and then

injecting from each air-fuel injector into the space above the molten glass in the channel a premixed mixture of air and fuel at a velocity greater than 50 ft/sec in which the amount of air in the mixture injected from the injector is between 25% to 60% (preferably 30% to 50%, most preferably 30 to 40%) of the stoichiometric air required for complete combustion of the fuel in the mixture injected from the same injector, and

injecting from each oxygen injector into the space above the molten glass in the channel gaseous oxidant containing at least 80 vol. % oxygen at a velocity less than 50 ft/sec (preferably less than 30 ft/sec) and at a rate that provides sufficient oxygen, taken together with the oxygen content of the mixture of air and fuel that is injected from the air-fuel injectors, to completely combust the fuel that is injected from the fuel injectors,

wherein there is no physical barrier between the molten glass and the space into which the mixture of air and fuel, and the gaseous oxidant, are injected, and

in the space above the molten glass combusting the fuel injected from the air-fuel injectors with the oxygen in the air and with the oxygen injected from the oxygen injectors so as to generate excess oxygen in the flue gas.

Preferably, in this embodiment and in all other embodiments herein in which air-fuel burners are removed and replaced with air-fuel injectors or with oxygen injectors, air-fuel burners are replaced with air-fuel injectors at a ratio of one air-fuel injector for each two to twelve air-fuel burners, preferably two to six air-fuel burners that are replaced, and air-fuel burners are replaced with oxygen injectors at a ratio of one oxygen injector for each two to twelve air-fuel burners, preferably two to six air-fuel burners that are replaced, it being understood that the number of air-fuel injectors that replace a given number of air-fuel burners that are removed does not have to be the same number as the number of oxygen injectors that replace the given number of air-fuel burners that are removed.

A second embodiment of this invention is a method comprising:

in a forehearth system in which molten glass from a glassmelting furnace flows through one or more channels having refractory side walls, maintaining the molten glass in the channels in the molten state by heat of combustion which is provided to the space above the molten glass, by:

injecting into the space above the molten glass, from one or more air-fuel injectors each of which opens at its own refractory port in a side wall of the channel, a premixed mixture of air and fuel at a velocity greater than 50 ft/sec in which the amount of air in the mixture injected from the air-fuel injector is between 25% to 60% (preferably 30% to 50%, more preferably 30% to 40%) of the stoichiometric air required for complete combustion of the fuel in the mixture injected from the same injector, and

injecting into the space above the molten glass, from one or more oxygen injectors each of which opens at its own refractory port in a side wall of the channel, gaseous oxidant containing at least 80 vol. % oxygen at a velocity less than 50 ft/sec (preferably less than 30 ft/sec) and at a rate that provides sufficient oxygen, taken together with the oxygen content of the mixture of air and fuel that is injected from the air-fuel injectors, to completely combust the fuel that is injected from the fuel injectors,

wherein there is no physical barrier between the molten glass and the space into which the mixture of air and fuel, and the gaseous oxidant, are injected, and

in the space above the molten glass, combusting the fuel injected from the air-fuel injectors with the oxygen in the air and with the oxygen injected from the oxygen injectors so as to generate excess oxygen in the flue gas.

Alternatively, in forehearth systems having no physical barrier above the molten glass, it may be desired not to employ separate air-fuel injectors and oxidant injectors. For such situations, another embodiment of the present invention is a method comprising:

from a forehearth system in which molten glass from a glassmelting furnace flows through one or more channels having refractory side walls, wherein the molten glass in the channels is maintained in the molten state by heat of combustion provided directly to the top surface of the molten glass by combustion in a combustion zone above the molten glass in the forehearth system that contains at least 2 air-fuel burners at which air and fuel fed to the air-fuel burners are combusted to provide the heat of combustion,

removing at least 50%, preferably all, of said air-fuel burners and replacing them with one or more hybrid burners including a central gaseous oxidant injector pipe and an annular passage for a premixed mixture of air and fuel wherein each hybrid burner opens at its own refractory burner port in a side wall of the channel and is recessed from the hot surface of the side wall, and each hybrid burner is capable of injecting a combustible gas mixture of gaseous oxidant and a premixed mixture of air and fuel into the space in the channel over the molten glass,

wherein said gaseous oxidant contains at least 80 vol. % oxygen and the amount of air in the premixed mixture is between 25% to 60% (preferably 30% to 50%, more preferably 30 to 40%) of the stoichiometric air required for complete combustion of the fuel in the premixed mixture and said air-fuel burners are replaced with hybrid burners at a ratio of one hybrid burner for each two to twelve air-fuel burners, preferably two to six air-fuel burners, that are replaced, wherein said gaseous oxidant is injected at a velocity greater than 100 ft/sec, preferably greater than 200 ft/sec, more preferably 300 ft/sec, in which the total amount of oxygen in the combustible gas mixture injected from the hybrid burner is sufficient for complete combustion of the fuel injected from the same burner and the flame length is less than the width of the channel, wherein there is no physical barrier between the molten glass and the space into which the mixture of oxidant and fuel is injected, and

combusting the fuel injected from the hybrid burners in the space above the molten glass with excess oxygen in flue gas.

A second aspect of this alternative is a method comprising:

in a forehearth system in which molten glass from a glassmelting furnace flows through a channel having refractory side walls, maintaining the molten glass in the channel in the molten state by heat of combustion which is provided directly to the top surface of the molten glass, by:

injecting a combustible gas mixture into the space above the molten glass from one or more hybrid burners each including a central gaseous oxidant injector pipe and an annular passage for a premixed mixture of air and fuel wherein each hybrid burner opens at its own refractory burner port in a side wall of the channel and is recessed from the hot surface of the side wall, and each hybrid burner is capable of injecting a combustible gas mixture of gaseous oxidant and a premixed mixture of air and fuel into the space in the channel over the molten glass,

wherein said gaseous oxidant contains at least 80 vol. % oxygen and the amount of air in the premixed mixture is between 25% to 60% (preferably 30% to 50%, more preferably 30 to 40%) of the stoichiometric air required for complete combustion of the fuel in the premixed mixture,

wherein said gaseous oxidant is injected at a velocity greater than 100 ft/sec, preferably greater than 200 ft/sec, more preferably greater than 300 ft/sec, in which the total amount of oxygen in the combustible gas mixture injected from the hybrid burner is sufficient for complete combustion of the fuel injected from the same burner and the flame length is less than the width of the channel,

wherein there is no physical barrier between the molten glass and the space into which the mixture of oxidant and fuel is injected, and

combusting the fuel injected from the hybrid burners in the space above the molten glass with excess oxygen in flue gas.

In another type of forehearth system, to which this invention is applicable, there is a physical barrier (also referred to as a cover) above the top surface of the molten glass, and heat is provided to the molten glass in the channel, below the cover, from flames of combustion in the region above the cover. This mode of heat transfer to the molten glass is termed “indirect” herein as it involves heat transfer from the flames to the cover, which is thereby heated, and it also involves heat transfer from the heated cover to the molten glass.

For this type of forehearth system, one embodiment of the present invention is a method comprising:

from a forehearth system in which molten glass from a glassmelting furnace flows through one or more channels having refractory side walls, wherein the forehearth system includes a physical barrier above the molten glass, and wherein the molten glass in the channels is maintained in the molten state by indirect transfer to the molten glass of heat of combustion carried out in the region above the physical barrier, wherein the forehearth system contains a combustion zone above the barrier with at least 2 air-fuel burners at which air and fuel fed to the air-fuel burners are combusted to provide the heat of combustion,

removing at least 50%, and preferably all, of said air-fuel burners and replacing them with one or more air-fuel injectors each of which opens at its own refractory port in a side wall of the channel and each of which is capable of injecting a premixed mixture of air and fuel into a region above the physical barrier over the molten glass, and with one or more oxygen injectors each of which opens at its own refractory port in a side wall of the channel and each of which is capable of injecting gaseous oxidant into a region above the physical barrier over the molten glass,

wherein the sum of the number of said air-fuel injectors plus the number of said oxygen injectors, which replace said air-fuel burners, is less than the number of air-fuel burners that are removed,

and then

injecting from each air-fuel injector into the region above the physical barrier in the channel a premixed mixture of air and fuel at a velocity greater than 50 ft/sec in which the amount of air in the mixture injected from the injector is between 25% to 60% (preferably 30% to 50%), most preferably 30% to 40%, of the stoichiometric air required for complete combustion of the fuel in the mixture injected from the same injector, and

injecting from each oxygen injector into the region above the physical barrier in the channel gaseous oxidant containing at least 80 vol. % oxygen at a velocity less than 50 ft/sec (preferably less than 30 ft/sec), and at a rate that provides sufficient oxygen, taken together with the oxygen content of the mixture of air and fuel that is injected from the air-fuel injectors, to completely combust the fuel that is injected from the fuel injectors, and in the region above the barrier combusting the fuel injected from the air-fuel injectors with the oxygen in the air and with the oxygen injected from the oxygen injectors so as to generate excess oxygen in flue gas.

A further embodiment of the present invention is a method comprising:

in a forehearth system in which molten glass from a glassmelting furnace flows through one or more channels having refractory side walls, wherein the forehearth system includes a physical barrier above the molten glass, maintaining the molten glass in the channels in the molten state by indirect transfer to the molten glass of heat of combustion carried out in the region above the physical barrier, by:

injecting into the region above the physical barrier, from one or more air-fuel injectors each of which opens at its own refractory port in a side wall of the channel, a premixed mixture of air and fuel at a velocity greater than 50 ft/sec in which the amount of air in the mixture injected from the air-fuel injector is between 25% to 60%, preferably 30% to 50%, and more preferably 30% to 40%, of the stoichiometric air required for complete combustion of the fuel in the mixture injected from the same injector, and

injecting into the region above the physical barrier, from one or more oxygen injectors each of which opens at its own refractory port in a side wall of the channel, gaseous oxidant containing at least 80 vol. % oxygen at a velocity less than 50 ft/sec (preferably less than 30 ft/sec) and at a rate that provides sufficient oxygen, taken together with the oxygen content of the mixture of air and fuel that is injected from the air-fuel injectors, to completely combust the fuel that is injected from the fuel injectors, and

in the region above the barrier, combusting the fuel injected from the air-fuel injectors with the oxygen in the air and with the oxygen injected from the oxygen injectors so as to generate excess oxygen in the flue gas.

Alternatively, in forehearth systems having a physical barrier above the molten glass, it may be desired not to employ separate air-fuel injectors and oxidant injectors. For such situations, another embodiment of the present invention is a method comprising: from a forehearth system in which molten glass from a glassmelting furnace flows through one or more channels having refractory side walls, wherein the forehearth system includes a physical barrier above the molten glass, wherein the molten glass in the channels is maintained in the molten state by indirect transfer to the molten glass of heat of combustion carried out in the region above the physical barrier by combustion, and wherein the forehearth system includes a combustion zone including at least 2 air-fuel burners at which air and fuel fed to the air-fuel burners are combusted to provide the heat of combustion,

removing at least 50%, preferably all, of said air-fuel burners and replacing them with one or more hybrid burners including a central gaseous oxidant injector pipe and an annular passage for a premixed mixture of air and fuel wherein each hybrid burner opens at its own refractory burner port in a side wall of the channel and is recessed from the hot surface of the side wall, and each hybrid burner is capable of injecting a combustible gas mixture of gaseous oxidant and a premixed mixture of air and fuel into the space in the channel over the molten glass,

wherein said gaseous oxidant contains at least 80 vol. % oxygen and the amount of air in the premixed mixture is between 25% to 60% (preferably 30% to 50%, more preferably 30 to 40%) of the stoichiometric air required for complete combustion of the fuel in the premixed mixture and said air-fuel burners are replaced with hybrid burners at a ratio of one hybrid burner for each two to twelve air-fuel burners, preferably two to six air-fuel burners, that are replaced, wherein said gaseous oxidant is injected at a velocity greater than 100 ft/sec, preferably greater than 200 ft/sec, more preferably 300 ft/sec, in which the total amount of oxygen in the combustible gas mixture injected from the hybrid burner is sufficient for complete combustion of the fuel injected from the same burner and the flame length is less than the width of the channel,

and combusting the fuel injected from the hybrid burners with excess oxygen in the flue gas in the region above the physical barrier.

Another embodiment of this aspect of the invention is a method comprising:

in a forehearth system in which molten glass from a glassmelting furnace flows through one or more channels having refractory side walls, wherein the forehearth system includes a physical barrier above the molten glass, maintaining the molten glass in the channels in the molten state by indirect transfer to the molten glass of heat of combustion which is carried out in the region above the physical barrier, by:

injecting a combustible gas mixture into the space above the molten glass from one or more hybrid burners each including a central gaseous oxidant injector pipe and an annular passage for a premixed mixture of air and fuel wherein each hybrid burner opens at its own refractory burner port in a side wall of the channel and is recessed from the hot surface of the side wall, and each hybrid burner is capable of injecting a combustible gas mixture of gaseous oxidant and a premixed mixture of air and fuel into the space in the channel over the molten glass,

wherein said gaseous oxidant contains at least 80 vol. % oxygen and the amount of air in the premixed mixture is between 25% to 60% (preferably 30% to 50%, more preferably 30 to 40%) of the stoichiometric air required for complete combustion of the fuel in the premixed mixture,

wherein said gaseous oxidant is injected at a velocity greater than 100 ft/sec, preferably greater than 200 ft/sec, more preferably greater than 300 ft/sec, in which the total amount of oxygen in the combustible gas mixture injected from the hybrid burner is sufficient for complete combustion of the fuel injected from the same burner and the flame length is less than the width of the channel, and

combusting the fuel injected from the hybrid burners in the space above the molten glass with excess oxygen in the flue gas.

As used herein, “removing” means completely removing an integral item of equipment, such as a burner, in which case “replacing” means installing another integral item of equipment in place of the item that was removed; and “removing” and “replacing” as used herein also mean changing one or more components of an item of equipment (without necessarily changing all of the item), or physically changing its capability to perform a function or to perform a function in a particular manner or degree, in which case “replacing” then means establishing the item of equipment with that physical change to its overall construction or to its capability to perform a function in a particular manner or degree.

### BRIEF DESCRIPTION OF THE DRAWINGS

FIG. 1 is a flowchart showing an overview of a glass manufacturing facility.

FIGS. 2A and 2B are cutaway views, in perspective and in cross-section respectively, of a portion of a forehearth without a cover.

FIGS. 3A and 3B are cutaway views, in perspective and in cross-section respectively, of a portion of a forehearth with a cover.

FIG. 4 is a top view of a portion of a forehearth without a cover.

FIG. 5 is a side cross-sectional view of an injector useful in the present invention.

### DETAILED DESCRIPTION OF THE INVENTION

The present invention is useful in improving the efficiency of glass manufacture.

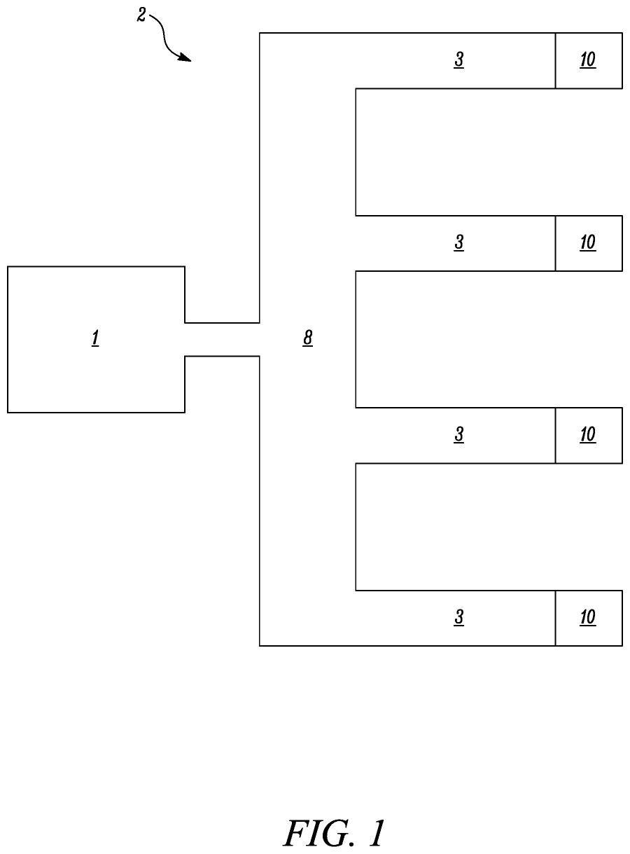

Referring to FIG. 1, glass manufacture conventionally includes melting glassmaking components in a furnace which is represented as 1 in FIG. 1. Glassmaking materials are fed into furnace 1 where they are heated, typically by combustion within the furnace, to melt the materials thereby forming molten glass and to maintain the molten glass in the molten state. The resulting molten material, referred to as molten glass or glassmelt, passes from furnace 1 (or from a refining zone which for this description is considered to be part of furnace 1) into forehearth system 2 which comprises a distributor section 8 and a series of channels 3 in which the glassmelt flows to reach forming stations 10 in which the glassmelt is formed into the products or shapes that the operator desires. Molten glass is conditioned in the forehearth system so that it achieves a desired uniform temperature when the molten glass arrives at the forming stations 10. Typically, many small burners are used to provide temperature uniformity along the path taken by the molten glass. Each distributor section and each channel has one or more combustion zone(s) and each zone is fired with at least one burner.

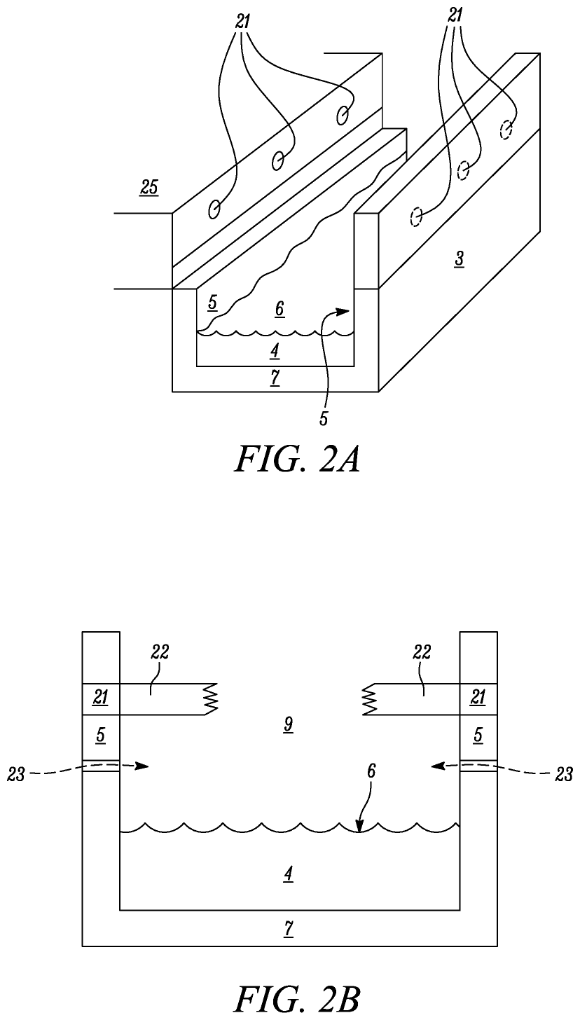

Referring to FIGS. 2A and 2B, the channel 3 of the forehearth system includes side walls 5 and bottom 7, which are formed from refractory material that can withstand the high temperatures of the flowing glassmelt 4 (that is, temperatures which are typically on the order of 2200 F. to 2700 F.).

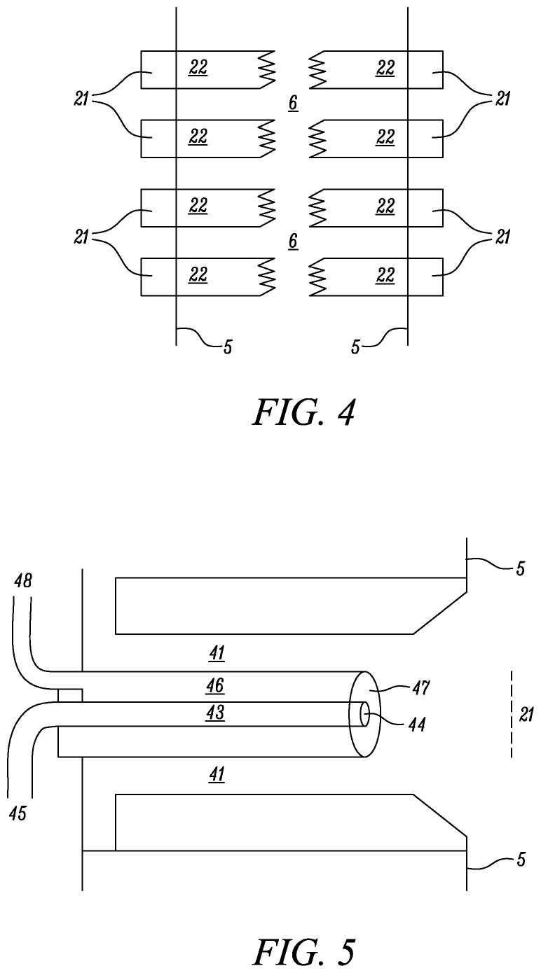

The forehearth system includes apparatus at which combustion occurs in combustion zone 9 which provides heat of combustion to the top surface 6 of the glassmelt 4. In the embodiment shown in FIGS. 2A, 2B and 4, in which heat is provided to the molten glass directly (as that term is defined herein), the apparatus includes burners or injectors 21 which are arrayed side by side in burner blocks 25 on each side of the channel 3. At these burners 21, combustion of fuel and oxidant (air) forms flames 22 which extend into the space above the top surface 6 of glassmelt 4. Above the burner blocks there are side walls (not shown) and a roof (not shown) to enclose the combustion zone 9. Preferably, the flames extend from each side wall 5 of the channel 3 approximately halfway across the surface 6. The burners 21 on each side of channel 3 can be directly across from each other, as shown in FIG. 4, or can be staggered so that a burner on one side of channel 3 projects toward the space between adjacent burners on the other side.

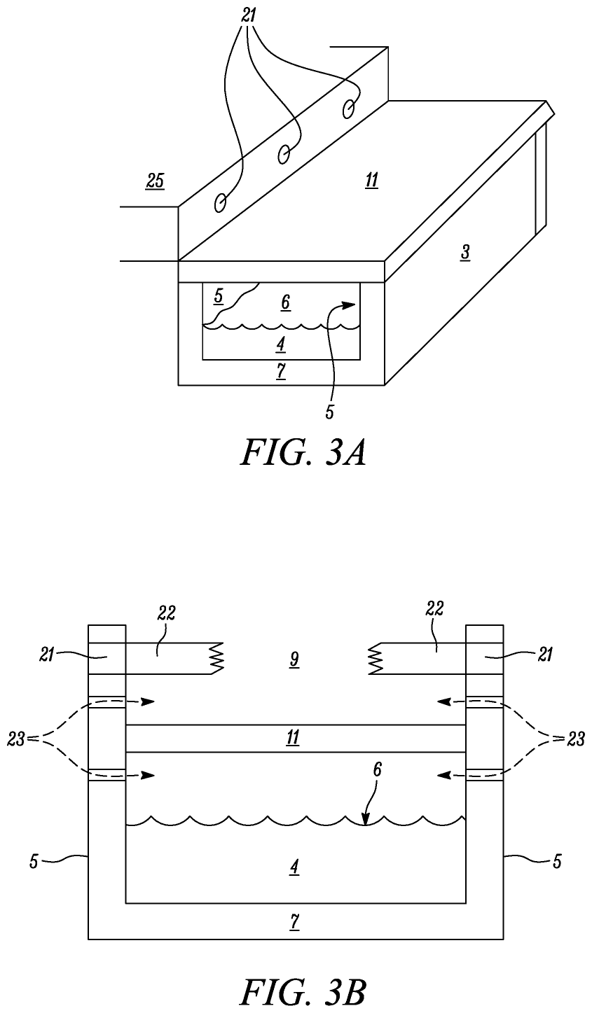

FIGS. 3A and 3B show an alternative structure of forehearth system, in which a cover or physical barrier 11 is located between the top surface 6 of the glassmelt 4 and the burners or injectors 21 and the flames 22 which emanate from the burners 21. Combustion of fuel and oxidant occurs in combustion zone 9 which is in the region above cover 11. In this alternate embodiment heat transfer to the molten glass is indirect, which may provide more uniform heating of the molten glass and may lessen the risk of adverse interaction between the flames and the top surface of the molten glass. The physical barriers 11 should be made of material that can withstand the aforementioned high temperatures, yet permit heat to reach the surface 6, such as by conduction or absorption and re-radiation toward the surface 6. Preferably the physical barrier extends the full width of the channel and prevents combustion gases to come in contact with the glassmelt.

Referring to FIG. 2B, optionally, a stream 23 (shown in dashed lines as being optional) of gas can be injected through one or both of side walls 5 into the space above surface 6. Referring to FIG. 3B, optional stream 23 can be injected into the space below the cover 11. In another embodiment, the gas stream 23 can optionally flow into the region above cover 11 where it may participate in the combustion in that region. This gas stream 23 can be an oxidizing composition, such as air or oxygen-enriched air, or a stream containing at least 80 vol. % oxygen; or it can be a reducing composition, comprising hydrogen and/or carbon monoxide and/or other reducing component(s); or it can be neither oxidizing nor reducing, such as nitrogen and/or argon.

In typical forehearth systems with which the present invention is applicable, the burners 21 are air-fuel burners, that is, premixed air and fuel are fed to each burner 21 and combusted to create heat of combustion (and flames 22). Selected numbers of these air-fuel burners are replaced with either a combination of air-fuel injectors and injectors which inject gaseous oxidant, or with hybrid fuel-oxygen burners described below with respect to FIG. 5.

In any of the embodiments of the present invention that employ fuels, the preferred fuels are gaseous hydrocarbons such as natural gas, methane, ethane, propane, butane, and mixtures thereof. In the embodiments of the present invention that employ separate air-fuel injectors and oxidant injectors, or that employ hybrid fuel-oxygen injectors, the preferred oxidants are gaseous compositions containing at least 80 vol. % oxygen.

In the embodiments of the present invention that replace air-fuel burners with separate injectors of air-fuel mixture and injectors of gaseous oxidant, the preferred characteristics are:

The flow rate of the air-fuel mixture is 20 to 400 scfh, preferably 40 to 200 scfh. (It will be understood by those skilled in this art that the firing rate and the air-fuel flow rate which are required in a given forehearth system depend on the size of the forehearth.)
The fuel-rich air-fuel mixture contains 25% to 60% (preferably 30% to 50%, more preferably 30 to 40%) of the oxygen needed to completely combust the fuel in the mixture.
The flow rate of gaseous oxidant with or without the aforementioned cover 11 being present is 10 to 50 scfh, preferably 15 to 40 scfh.
The velocity of the gaseous oxidant from oxidant injector with or without the aforementioned cover 11 being present is less than 50 ft/sec, preferably less than 20 ft/sec.

Preferably, in these aspects of the invention, the ports through which gaseous oxidant is injected are spaced from any port through which the air-fuel mixture is injected, by a distance measured between the points at which adjacent ports are closest to each other, of at least two times the diameter of the larger port.

In each of these aspects of the invention, it is preferred that the ratio of the momentum flux (which is defined as the mass flow rate of a gas stream times the velocity of the gas stream) of the gaseous oxidant stream from oxidant injector to the momentum flux of the premixed mixture stream of air and fuel from air-fuel injector is between 0.02 to 0.4, preferably 0.1 to 0.3, more preferably 0.1 to 0.2.

With this aspect of the invention, the air-fuel burners can be replaced at a ratio of 2 to 12 air-fuel burners, preferably 2 to 6, replaced by each one air-fuel injector plus each one gaseous oxidant injector. Replacement can be effected by physically removing a burner, and plugging the holes in side walls 5 that remain where a burner was removed and was not replaced at the same location with an air-fuel injector or with an oxidant injector.

In other embodiments of the present invention, 25% to 87.5% of existing air-fuel burners are removed and the remaining air-fuel burners are modified to become hybrid burners such as depicted in FIG. 5. Referring to FIG. 5, an air-fuel burner had included conduit 46 that is centrally positioned in cavity 41 and ends in opening 47 which is recessed from the port opening 21 of cavity 41 in side wall 5. Premixed fuel and air is fed through inlet 48 into conduit 46. This air-fuel burner can be modified in the practice of the present invention by inserting feed tube 43 into conduit 46, preferably to be coaxially aligned with the axis of conduit 46. Feed tube 43 ends at opening 44 which is recessed from the port opening 21 of cavity 41 in side wall 5. Gaseous oxidant is fed through inlet 45 into feed tube 43.

This embodiment of the present invention has the advantages that fewer ports need to be established than is the case with separate provision of air-fuel injectors and oxidant injectors. Also, retrofitting is eased because an existing air-fuel burner and burner port can be transformed, without having to create additional openings in side wall 5, simply by inserting feed tube 43 into the existing air-fuel burner body and cavity 41 which had been occupied by the air-fuel burner.

The end 44 of feed tube 43 is recessed from the port 21 in order to minimize the risk of deposit formation on the end due to coking of hydrocarbons or due to condensation of vapors of glassforming products or byproducts such as sodium hydroxide or sodium sulfate.

In the embodiments of the present invention that modify and replace air-fuel burners with a hybrid burner such as shown in FIG. 5, the preferred characteristics are:

The flow rate of the air-fuel mixture is 20 to 400 scfh, and preferably 40 to 200 scfh. (It will be understood by those skilled in this art that the firing rate and the air-fuel flow rate which are required in a given forehearth system depend on the size of the forehearth.)
The fuel-rich air-fuel mixture contains 25% to 60%, preferably 30% to 50%, more preferably 30 to 40%, of the oxygen needed to completely combust the fuel in the mixture. The velocity of gaseous oxidant from hybrid burner with or without cover 11 is greater than 100 ft/sec, preferably greater than 200 ft/sec, more preferably greater than 300 ft/sec.

1. A method comprising:
from a forehearth system in which molten glass from a glassmelting furnace flows through one or more channels having refractory side walls, wherein the molten glass in the channels is maintained in the molten state by heat of combustion provided directly to the top surface of the molten glass by combustion in a combustion zone above the molten glass in the forehearth system that has at least 2 air-fuel burners at which air and fuel fed to the air-fuel burners are combusted to provide the heat of combustion,
removing at least 50% of said air-fuel burners and replacing them with one or more air-fuel injectors each of which opens at its own refractory port in a side wall of the channel and each of which is capable of injecting a premixed mixture of air and fuel into the space in the channel over the molten glass, and with one or more oxygen injectors each of which opens at its own refractory port in a side wall of the channel and each of which is capable of injecting gaseous oxidant into the space in the channel over the molten glass,
wherein the sum of the number of said air-fuel injectors plus the number of said oxygen injectors, which replace said air-fuel burners, is less than the number of air-fuel burners that are removed, and then
injecting from each air-fuel injector into the space above the molten glass in the channel a premixed mixture of air and fuel at a velocity greater than 50 ft/sec in which the amount of air in the mixture injected from the injector is between 25% to 60% of the stoichiometric air required for complete combustion of the fuel in the mixture injected from the same injector, and
injecting from each oxygen injector into the space above the molten glass in the channel gaseous oxidant containing at least 80 vol. % oxygen at a velocity less than 50 ft/sec and at a rate that provides sufficient oxygen, taken together with the oxygen content of the mixture of air and fuel that is injected from the air-fuel injectors, to completely combust the fuel that is injected from the fuel injectors,
wherein there is no physical barrier between the molten glass and the space into which the mixture of air and fuel, and the gaseous oxidant, are injected, and
in the space above the molten glass combusting the fuel injected from the air-fuel injectors with the oxygen in the air and with the oxygen injected from the oxygen injectors so as to generate excess oxygen in the flue gas.

2. A method according to claim 1 wherein all of said air-fuel burners are removed and replaced with one or more of said air-fuel injectors.

3.-5. (canceled)

6. A method according to claim 1 further comprising injecting a gas that is oxidizing, reducing, or neither oxidizing nor reducing, through at least one side wall into the space above the molten glass.

7. A method comprising:
in a forehearth system in which molten glass from a glassmelting furnace flows through one or more channels having refractory side walls, maintaining the molten glass in the channels in the molten state by heat of combustion which is provided to the space above the molten glass, by:
injecting into the space above the molten glass, from one or more air-fuel injectors each of which opens at its own refractory port in a side wall of the channel, a premixed mixture of air and fuel at a velocity greater than 50 ft/sec in which the amount of air in the mixture injected from each air-fuel injector is between 25% to 60% of the stoichiometric air required for complete combustion of the fuel in the mixture injected from the same injector, and
injecting into the space above the molten glass, from one or more oxygen injectors each of which opens at its own refractory port in a side wall of the channel, gaseous oxidant containing at least 80 vol. % oxygen at a velocity less than 50 ft/sec and at a rate that provides sufficient oxygen, taken together with the oxygen content of the mixture of air and fuel that is injected from the air-fuel injectors, to completely combust the fuel that is injected from the fuel injectors,
wherein there is no physical barrier between the molten glass and the space into which the mixture of air and fuel, and the gaseous oxidant, are injected, and
in the space above the molten glass combusting the fuel injected from the air-fuel injectors with the oxygen in the air and with the oxygen injected from the oxygen injectors so as to generate excess oxygen in the flue gas.

8.-10. (canceled)

11. A method according to claim 7 further comprising injecting a gas that is oxidizing, reducing, or neither oxidizing nor reducing, through at least one side wall into the space above the molten glass.

12. A method comprising:
from a forehearth system in which molten glass from a glassmelting furnace flows through one or more channels having refractory side walls, wherein the molten glass in the channels is maintained in the molten state by heat of combustion provided directly to the top surface of the molten glass by combustion in a combustion zone above the molten glass in the forehearth system that contains at least 2 air-fuel burners at which air and fuel fed to the air-fuel burners are combusted to provide the heat of combustion,
removing at least 50% of said air-fuel burners and replacing them with one or more hybrid burners including a central gaseous oxidant injector pipe and an annular passage for a premixed mixture of air and fuel wherein each hybrid burner opens at its own refractory burner port in a side wall of the channel and is recessed from the hot surface of the side wall, and each hybrid burner is capable of injecting a combustible gas mixture of gaseous oxidant and a premixed mixture of air and fuel into the space in the channel over the molten glass,
wherein said gaseous oxidant contains at least 80 vol. % oxygen and the amount of air in the premixed mixture is between 25% to 60% of the stoichiometric air required for complete combustion of the fuel in the premixed mixture and said air-fuel burners are replaced with hybrid burners at a ratio of one hybrid burner for each two to twelve air-fuel burners, that are replaced,
wherein said gaseous oxidant is injected at a velocity greater than 100 ft/sec, in which the total amount of oxygen in the combustible gas mixture injected from the hybrid burner is sufficient for complete combustion of the fuel injected from the same burner and the flame length is less than the width of the channel,
wherein there is no physical barrier between the molten glass and the space into which the mixture of oxidant and fuel is injected, and
combusting the fuel injected from the hybrid burners in the space above the molten glass with excess oxygen in flue gas.

13. A method according to claim 12 wherein all of said air-fuel burners are removed and replaced with one or more of said hybrid burners.

14.-18. (canceled)

19. A method according to claim 12 further comprising injecting a gas that is oxidizing, reducing, or neither oxidizing nor reducing, through at least one side wall into the space above the molten glass.

20. A method comprising:
in a forehearth system in which molten glass from a glassmelting furnace flows through a channel having refractory side walls, maintaining the molten glass in the channel in the molten state by heat of combustion which is provided directly to the top surface of the molten glass, by:
injecting a combustible gas mixture into the space above the molten glass from one or more hybrid burners each including a central gaseous oxidant injector pipe and an annular passage for a premixed mixture of air and fuel wherein each hybrid burner opens at its own refractory burner port in a side wall of the channel and is recessed from the hot surface of the side wall, and each hybrid burner is capable of injecting a combustible gas mixture of gaseous oxidant and a premixed mixture of air and fuel into the space in the channel over the molten glass,
wherein said gaseous oxidant contains at least 80 vol. % oxygen and the amount of air in the premixed mixture is between 25% to 60% of the stoichiometric air required for complete combustion of the fuel in the premixed mixture,
wherein said gaseous oxidant is injected at a velocity greater than 100 ft/sec, in which the total amount of oxygen in the combustible gas mixture injected from the hybrid burner is sufficient for complete combustion of the fuel injected from the same burner and the flame length is less than the width of the channel,
wherein there is no physical barrier between the molten glass and the space into which the mixture of oxidant and fuel is injected, and
combusting the fuel injected from the hybrid burners in the space above the molten glass with excess oxygen in flue gas.

21.-24. (canceled)

25. A method according to claim 20 further comprising injecting a gas that is oxidizing, reducing, or neither oxidizing nor reducing, through at least one side wall into the space above the molten glass.

26. A method comprising:
from a forehearth system in which molten glass from a glassmelting furnace flows through one or more channels having refractory side walls, wherein the forehearth system includes a physical barrier above the molten glass, and wherein the molten glass in the channels is maintained in the molten state by indirect transfer to the molten glass of heat of combustion carried out in the region above the physical barrier, wherein the forehearth system contains a combustion zone above the barrier with at least 2 air-fuel burners at which air and fuel fed to the air-fuel burners are combusted to provide the heat of combustion,
removing at least 50% of said air-fuel burners and replacing them with one or more air-fuel injectors each of which opens at its own refractory port in a side wall of the channel and each of which is capable of injecting a premixed mixture of air and fuel into a region above the physical barrier over the molten glass, and with one or more oxygen injectors each of which opens at its own refractory port in a side wall of the channel and each of which is capable of injecting gaseous oxidant into a region above the physical barrier over the molten glass,
wherein the sum of the number of said air-fuel injectors plus the number of said oxygen injectors, which replace said air-fuel burners, is less than the number of air-fuel burners that are removed,
and then
injecting from each air-fuel injector into the region above the physical barrier in the channel a premixed mixture of air and fuel at a velocity greater than 50 ft/sec in which the amount of air in the mixture injected from the injector is between 25% to 60% of the stoichiometric air required for complete combustion of the fuel in the mixture injected from the same injector, and
injecting from each oxygen injector into the region above the physical barrier in the channel gaseous oxidant containing at least 80 vol. % oxygen at a velocity less than 50 ft/sec and at a rate that provides sufficient oxygen, taken together with the oxygen content of the mixture of air and fuel that is injected from the air-fuel injectors, to completely combust the fuel that is injected from the fuel injectors, and
in the region above the barrier combusting the fuel injected from the air-fuel injectors with the oxygen in the air and with the oxygen injected from the oxygen injectors so as to generate excess oxygen in flue gas.

27. A method according to claim 26 wherein all of said air-fuel burners are removed and replaced with one or more of said air-fuel injectors.

28.-30. (canceled)

31. A method according to claim 26 further comprising injecting a gas that is oxidizing, reducing, or neither oxidizing nor reducing, through at least one side wall into the space above the molten glass or into the region above the physical barrier.

32. A method comprising:
in a forehearth system in which molten glass from a glassmelting furnace flows through one or more channels having refractory side walls, wherein the forehearth system includes a physical barrier above the molten glass, maintaining the molten glass in the channels in the molten state by indirect transfer to the molten glass of heat of combustion carried out in the region above the physical barrier, by:
injecting into the region above the physical barrier, from one or more air-fuel injectors each of which opens at its own refractory port in a side wall of the channel, a premixed mixture of air and fuel at a velocity greater than 50 ft/sec in which the amount of air in the mixture injected from the air-fuel injector is between 25% to 60%, of the stoichiometric air required for complete combustion of the fuel in the mixture injected from the same injector, and
injecting into the region above the physical barrier, from one or more oxygen injectors each of which opens at its own refractory port in a side wall of the channel, gaseous oxidant containing at least 80 vol. % oxygen at a velocity less than 50 ft/sec and at a rate that provides sufficient oxygen, taken together with the oxygen content of the mixture of air and fuel that is injected from the air-fuel injectors, to completely combust the fuel that is injected from the fuel injectors, and
in the region above the barrier, combusting the fuel injected from the air-fuel injectors with the oxygen in the air and with the oxygen injected from the oxygen injectors so as to generate excess oxygen in the flue gas.

33.-35. (canceled)

36. A method according to claim 32 further comprising injecting a gas that is oxidizing, reducing, or neither oxidizing nor reducing, through at least one side wall into the space above the molten glass or into the region above the physical barrier.

37. A method comprising:
from a forehearth system in which molten glass from a glassmelting furnace flows through one or more channels having refractory side walls, wherein the forehearth system includes a physical barrier above the molten glass, wherein the molten glass in the channels is maintained in the molten state by indirect transfer to the molten glass of heat of combustion carried out in the region above the physical barrier by combustion, and wherein the forehearth system includes a combustion zone including at least 2 air-fuel burners at which air and fuel fed to the air-fuel burners are combusted to provide the heat of combustion,
removing at least 50% of said air-fuel burners and replacing them with one or more hybrid burners including a central gaseous oxidant injector pipe and an annular passage for a premixed mixture of air and fuel wherein each hybrid burner opens at its own refractory burner port in a side wall of the channel and is recessed from the hot surface of the side wall, and each hybrid burner is capable of injecting a combustible gas mixture of gaseous oxidant and a premixed mixture of air and fuel into the space in the channel over the molten glass,
wherein said gaseous oxidant contains at least 80 vol. % oxygen and the amount of air in the premixed mixture is between 25% to 60% of the stoichiometric air required for complete combustion of the fuel in the premixed mixture and said air-fuel burners are replaced with hybrid burners at a ratio of one hybrid burner for each two to twelve air-fuel burners that are replaced,
wherein said gaseous oxidant is injected at a velocity greater than 100 ft/sec, in which the total amount of oxygen in the combustible gas mixture injected from the hybrid burner is sufficient for complete combustion of the fuel injected from the same burner and the flame length is less than the width of the channel,
and combusting the fuel injected from the hybrid burners with excess oxygen in the flue gas in the region above the physical barrier.

38. A method according to claim 37 wherein all of said air-fuel burners are removed and replaced with one or more of said hybrid burners.

39.-43. (canceled)

44. A method according to claim 37 further comprising injecting a gas that is oxidizing, reducing, or neither oxidizing nor reducing, through at least one side wall into the space above the molten glass or into the region above the physical barrier.

45. A method comprising:
in a forehearth system in which molten glass from a glassmelting furnace flows through one or more channels having refractory side walls, wherein the forehearth system includes a physical barrier above the molten glass, maintaining the molten glass in the channels in the molten state by indirect transfer to the molten glass of heat of combustion which is carried out in the region above the physical barrier, by:
injecting a combustible gas mixture into the space above the molten glass from one or more hybrid burners each including a central gaseous oxidant injector pipe and an annular passage for a premixed mixture of air and fuel wherein each hybrid burner opens at its own refractory burner port in a side wall of the channel and is recessed from the hot surface of the side wall, and each hybrid burner is capable of injecting a combustible gas mixture of gaseous oxidant and a premixed mixture of air and fuel into the space in the channel over the molten glass,
wherein said gaseous oxidant contains at least 80 vol. % oxygen and the amount of air in the premixed mixture is between 25% to 60% of the stoichiometric air required for complete combustion of the fuel in the premixed mixture,
wherein said gaseous oxidant is injected at a velocity greater than 100 ft/sec, in which the total amount of oxygen in the combustible gas mixture injected from the hybrid burner is sufficient for complete combustion of the fuel injected from the same burner and the flame length is less than the width of the channel,
and
combusting the fuel injected from the hybrid burners in the space above the molten glass with excess oxygen in the flue gas.

46.-49. (canceled)

50. A method according to claim 45 further comprising injecting a gas that is oxidizing, reducing, or neither oxidizing nor reducing, through at least one side wall into the space above the molten glass or into the region above the physical barrier.
